(19) United States
(12) Patent Application Publication
(10) Pub. No.: US 2005/0169388 A1
(43) Pub. Date: Aug. 4, 2005

(54) Increased ultra wideband (UWB) user capacity transmitter utilizing time and frequency reuse approaches

(76) Inventors: Brent T. Toland, Redondo Beach, CA (US); Barry R. Allen, Rolling Hills Estates, CA (US); Gerald R. Fischer, Playa Del Rey, CA (US)

Correspondence Address: Connie M. Thousand;Northrop Grumman Space & Mission Systems Corp., One Space Park, Bldg. E1/2041, Redondo Beach, CA, 90278, US

(21) Appl. No.: 10/773,072

(22) Filed: Feb. 4, 2004

(51) Int. Cl. H04L 27/00

(52) U.S. Cl. 375/259

(57) ABSTRACT

An ultra wideband (UWB) communication system and method for its use, allowing multiple users to communicate with the system without significant interference. The system includes multiple element antenna array, through which UWB pulses are transmitted to selected multiple users, by means of a selected combination of spatial multiplexing, frequency reuse and time slot reuse.

### BACKGROUND OF THE INVENTION

The present invention relates generally to communication systems using ultra wideband (UWB) pulses and, more particularly, to techniques for increasing user capacity in UWB transmitters. Communication by UWB pulses, sometimes referred to as impulse radio communication, is a known but not widely used technique. The term “impulse radio” is generally used to describe UWB systems in which there is no carrier signal contained within the pulses. The term UWB may also be applied to systems in which the transmitted pulses are bursts of a radio frequency carrier signal. An extremely narrow electromagnetic pulse inherently contains a wide band of frequencies. Adding information to a stream of UWB pulses may be effected by pulse position modulation, wherein the instantaneous value of an information signal sample is used to modulate the position in time of a UWB pulse. At a more fundamental level, UWB pulses may also be modulated by their presence or absence in an otherwise periodic train of pulses. These principles are known in the technical literature and are conveniently summarized in U.S. Pat. No. 5,677,927, issued to Fullerton et al.

Because UWB communication utilizes a large band of the frequency spectrum, it offers the advantages of security and resistance to jamming. Because UWB communication utilizes bandwidth inefficiently, governmental authorization of its use has been limited to relatively low powers. UWB communication still offers the advantages of a relatively long range, the ability to penetrate walls of buildings, and low transceiver cost. However, communication by UWB pulses has some practical limitations, such as the difficulties inherent in applying the technique to multiple users. For example, one possible application of UWB communication systems is for supplying Internet and television connection to homes, as an alternative to coaxial cable, optical fiber cable, or satellite dish communication. UWB communication is ideal for this purpose because it permits the transmission of information at high data rates, using relatively low cost transceivers and processors at user sites. One inherent shortcoming of UWB communication systems, however, is that they allow only one user to receive unique information during any chosen time interval. The Fullerton et al. patent (U.S. Pat. No. 5,677,927) teaches the use of subcarriers of different frequencies or different waveforms to add channelization to impulse radio signals used in UWB transmission.

An analogous technique for providing multiple user access to communication systems is code division multiple access (CDMA), as used in mobile telephone systems. Multiple users of a CDMA system share the same frequency band and may transmit at the same time, but their information signals are distinguishable because each user is associated with a different code used for spectrum spreading. The codes are said to be orthogonal, i.e., in theory they are independently detectable in a receiver. Thus, in CDMA systems multiple information signal channels share a single spread-spectrum transmission system. Applying some form of CDMA to UWB transmission would, however, increase the complexity and cost of the modulation and detection equipment. It will be appreciated from the foregoing that there is still a need for a relatively simple approach for sharing UWB transmission systems among multiple users. The present invention is directed to this end.

### BRIEF SUMMARY OF THE INVENTION

The present invention resides in apparatus, and a related method, for directing selected ultra wideband (UWB) pulses to multiple users of a UWB communication system. Briefly, and in general terms the apparatus of the invention comprises a wideband antenna structure having multiple arrays configured symmetrically, each array having multiple antenna elements; and means for separating UWB pulses into individual user streams of pulses and applying each user stream to the antenna structure in such a way as to generate individual user beams containing only pulses intended for those respective users. In accordance with one aspect of the invention the pulses are separated into individual user streams by assigning to each user a particular allocation of UWB time slots. In the simplest form of the apparatus, the UWB pulses are directed to different users by applying each user stream to a different segment of the antenna.

More specifically, separating UWB pulses into individual user streams is effected by assigning to each user a unique combination of a UWB frequency and an antenna array, whereby the UWB pulses transmitted to or from particular users are all uniquely identifiable and any user may receive or transmit UWB pulses at the same time as other users, without significant interference. Spatial separation of user beams is further enhanced by the use of a plurality of beam forming networks, each associated with a separate one of the multiple antenna arrays, and each comprising a plurality of variable time delay circuits. The time delay circuits interpose different sets of selected time delays for UWB pulses applied to the successive array elements, to direct different pulses along beam paths to respective users. Beam steering signals are used to control the beam forming networks, to switch them in such a way as to effect beam steering toward selected users served by each antenna array.

In accordance with another important aspect of the invention, UWB pulses for each of the users have a carrier frequency selected from a plurality of available frequencies, and the frequencies are reused in a spatial sequence such that the beam associated with any user is spatially separated as far as possible from the nearest user beam using the same frequency.

It will be appreciated from the foregoing that the present invention provides a significant advance in the field of UWB communication systems. In particular, the invention allows UWB pulses to be directed to selected multiple users, using a selected combination of spatial beam separation, temporal separation and frequency reuse. Other aspects and advantages of the invention will become apparent from the following more detailed description, taken in conjunction with the accompanying drawings.

### BRIEF DESCRIPTION OF THE DRAWINGS

FIG. 1 is a diagrammatic view of a UWB antenna with separate arrays mounted on respective faces of a polygonal structure.

FIG. 2 is a diagrammatic view of a UWB antenna array employing beam steering for spatial separation of different user signals.

FIG. 3 is a representative timing diagram illustrating time slot reuse in a UWB communication system.

FIG. 4 is a diagrammatic view of a multi-faceted UWB antenna configuration employing frequency reuse to enhance signal separation for multiple users.

### DETAILED DESCRIPTION OF THE INVENTION

As shown in the drawings for purposes of illustration, the present invention pertains to techniques for sharing an ultra wideband (UWB) communication system among multiple users. For example, the users may be home owners having a need for delivery of wideband communication data from television or Internet service providers without using underground coaxial cables, optical fiber cables, or satellite dish antennas.

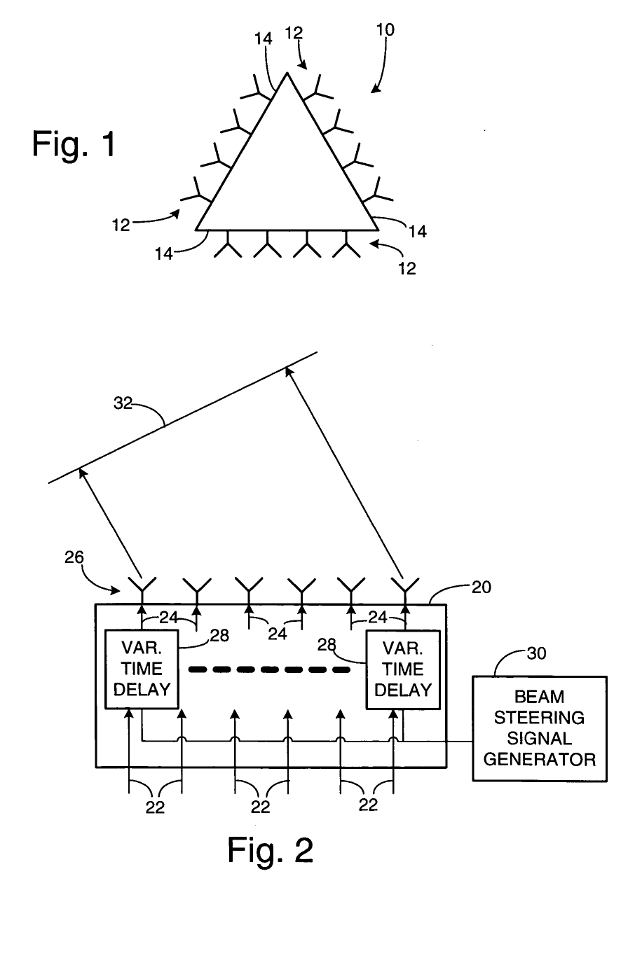

In accordance with one aspect of the invention, a centrally located UWB transmitting/receiving system includes a wideband antenna that provides for multiple, spatially separated antenna beams, each directed toward a separate user antenna. This multiple beam wideband antenna allows multiple UWB user channels to be spatially interleaved within a given time period. For example, as shown in FIG. 1, the multiple beam antenna, indicated generally by reference numeral 10, includes multiple antenna arrays 12 located on multiple faces 14 that form a polygon when viewed from above. In the illustrative antenna, there are three antenna arrays 12 located on three faces 14 that form a triangle in plan view. More generally, there may be N antenna arrays 12 installed on N faces 14 that form an N-sided polygon in plan view, allowing N separate transmission paths to separate users of the system.

Further spatial separation can be obtained by use of an analog or digital beam forming network 20 (FIG. 2.), the concept of which is analogous to the principle of a phased array antenna. In beam forming for UWB transmission, UWB pulses are applied to all input terminals 22 of the beam forming network 20. Output terminals 24 are connected to respective elements of an n-element antenna array 26. The beam forming network 20 functions to interpose time delays, two of which are shown at 28, selectively in the respective signal paths. The time delays 28 are controlled by a beam steering signal generator 30, which applies an incrementally greater delay to each successive input signal. For example, if the interposed time delays were all equal, UWB pulses would be applied in synchronism to all elements of the array 26. When an appropriate delay is applied to the UWB pulse transmitted to each successive element of the array 26, an electromagnetic pulse will be transmitted in a desired direction from the antenna array, as indicated by the wavefront 32. By digitally switching time delays in and out of the beam forming network 20, different selected pulses can be directed along different paths from the antenna array 26.

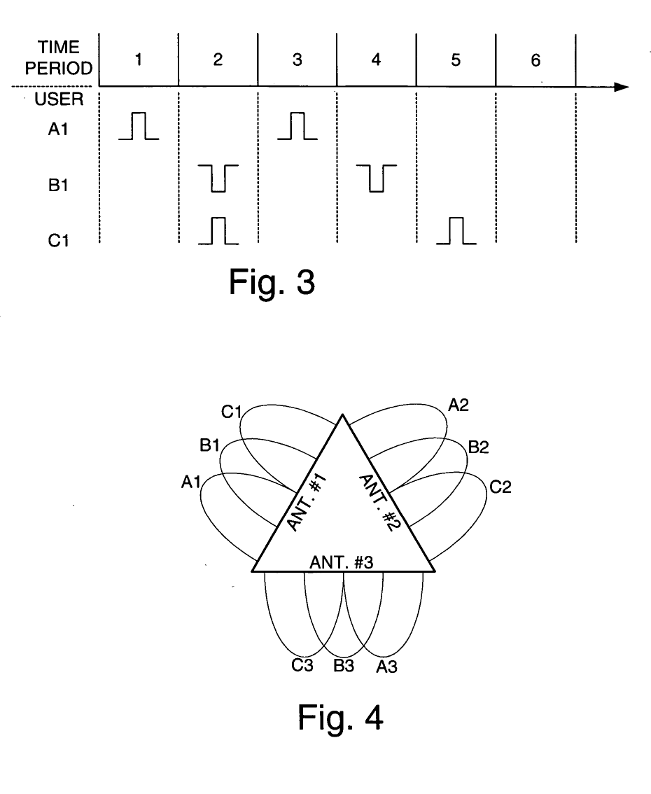

In addition to spatially multiplexing pulses, time multiplexing can be used. FIG. 3 is an example of time slot reuse to associate users with particular pulses. In the example, user A1 is associated with pulses in time slots #1 and #3 and user B1 is associated with negative-going pulses in time slots #2 and #4. User C1 is associated with positive-going pulses in time slots #2 and #5. Other arrangements are, of course, within the scope of the invention.

Instead of time reuse to identify particular pulses as being associated with particular users, the system may employ frequency reuse to separate the users. As shown in FIG. 4, for example, a three-array antenna is designed to generate three spatially separated beams from each of its three arrays. Antenna array #1 generates three spatially separated beams to users A1, B1 and C1, antenna array #2 generates three spatially separated beams to users A2, B2 and C2, and antenna array #3 generates three spatially separated beams to users A3, B3 and C3. In accordance with the frequency reuse principle as used here, the beams directed to users A1, A2 and A3 use a first frequency. Likewise, the beams directed to users B1, B2 and B3 use a second frequency, and the beams directed to users C1, C2 and C3 use a third frequency. That is to say, the UWB pulses associated with users A1, A2 and A3 have a first carrier frequency, while the pulses associated with users B1, B2 and B3 have a second carrier frequency, and the pulses associated with users C1, C2 and C3 have a third carrier frequency. Using this configuration, pulses for all nine users may overlap in time because they are separated spatially and by frequency at the antenna arrays. On any one of the arrays, the pulses intended for, say, user B are distinguishable from the signals intended for users A and C, because there is both frequency separation and spatial separation of the beams generated for that particular array. Moreover, the pulses for users using the same frequency, such as users A1, A2 and A3, are spatially separated in that they use separate physical antenna arrays.

It will be appreciated from the foregoing that the present invention represents a significant advance in the field of UWB communication systems, by providing multiple user access to a single transmitter/receiver. In particular, by a selected combination of spatial separation, beam steering, frequency reuse and time slot reuse, the invention permits multiple users to communicate with a UWB transceiver with only minimal interference. Although specific embodiments of the invention have been illustrated for purposes of illustration, various modifications may be made without departing from the spirit and scope of the invention. Accordingly, the invention should not be limited except as by the appended claims.

1. For use in an ultra wideband (UWB) communication system, apparatus capable of directing selected UWB pulses to and from selected multiple users, the apparatus comprising:
a wideband antenna structure having multiple arrays, each array having multiple antenna elements; and
means for separating UWB pulses into individual user streams of pulses and applying each user stream to the antenna structure in such a way as to generate individual user beams containing only pulses intended for those respective users.

2. Apparatus as defined in claim 1, wherein:
the means for separating UWB pulses into individual user streams comprises means for assigning to each user a particular allocation of UWB time slots.

3. Apparatus as defined in claim 1, wherein:
the means for separating UWB pulses into individual user streams comprises means for applying each user stream to a different segment of the antenna.

4. Apparatus as defined in claim 1, wherein:
the means for separating UWB pulses into individual user streams comprises means for assigning to each user a unique combination of a UWB frequency and an antenna array, whereby the UWB pulses transmitted to or from particular users are all uniquely identifiable and any user may receive or transmit UWB pulses at the same time as other users, without significant interference.

5. Apparatus as defined in claim 4, wherein the means for separating UWB pulses into user streams comprises:
a plurality of beam forming networks, each associated with a separate one of the multiple antenna arrays, and each comprising a plurality of variable time delay circuits, wherein the time delay circuits interpose different sets of selected time delays for UWB pulses applied to the successive array elements, to direct different pulses along beam paths to respective users; and
means for generating beam steering signals to the beam forming networks, to switch the beam forming networks to effect beam steering toward selected users served by each antenna array.

6. Apparatus as defined in claim 5, wherein:
each beam forming network is switchable to direct beams to a plurality (m) of users associated with each antenna array;
the antenna structure has n arrays, for a total of mn users;
UWB pulses for each of the mn users have a carrier frequency selected from a plurality of available frequencies; and
the frequencies are reused in a spatial sequence such that the beam associated with any user is spatially separated from other user beams using the same frequency.

7. A method for transmitting ultra wideband (UWB) pulses to selected multiple users, comprising the steps of:
separating UWB pulses by individual user; and
applying the UWB pulses to a wideband antenna structure having multiple arrays of multiple antenna elements.

8. A method as defined in claim 7, wherein:
the step of separating UWB pulses comprises assigning each user a particular allocation of time slots in a stream of UWB pulses.

9. A method as defined in claim 7, wherein:
the step of separating UWB pulses comprises applying each user's pulses to a different segment of the antenna structure.

10. A method as defined in claim 7, wherein:
the step of separating UWB pulses comprises assigning to each user a unique combination of a UWB frequency and an antenna array, whereby the UWB pulses transmitted to or from particular users are all uniquely identifiable and any user may receive or transmit UWB pulses at the same time as other users, without significant interference.

11. A method as defined in claim 10, wherein:
the step of separating UWB pulses comprises forming beams in a plurality of beam forming networks, each associated with a separate one of the multiple antenna arrays, wherein the step of forming beams includes interposing different sets of selected time delays for UWB pulses applied to the successive array elements, to direct different pulses along beam paths to respective users; and
the method further comprises generating beam steering signals to the beam forming networks, and thereby switching the beam forming networks to effect beam steering toward selected users served by each antenna array.

12. A method as defined in claim 11, wherein:
the step of switching the beam forming network functions to direct beams to a plurality (m) of users associated with each antenna array;
the antenna structure has n arrays, for a total of mn users; and
the method further comprises selecting, for each of the mn users, a UWB carrier frequency from a plurality of available frequencies, and reusing the frequencies in a spatial sequence such that the beam associated with any user is spatially separated from other user beams using the same frequency.
